(19) United States
(12) Patent Application Publication
(10) Pub. No.: US 2013/0247348 A1
(43) Pub. Date: Sep. 26, 2013

(54) SUNROOF DRAIN TUBE ASSEMBLY AND METHOD

(71) Applicants: Toshio Kitagawa, Dublin, OH (US); Takeshi Yamamoto, Dublin, OH (US)

(72) Inventors: Toshio Kitagawa, Dublin, OH (US); Takeshi Yamamoto, Dublin, OH (US)

(73) Assignee: HONDA MOTOR CO., LTD., Tokyo (JP)

(21) Appl. No.: 13/429,902

(22) Filed: Mar. 26, 2012

(51) Int. Cl. B23P 6/00; B23P 11/00; B23P 17/04

(52) U.S. Cl. 29/402.08; 29/428; 29/235

(57) ABSTRACT

A sunroof drain tube installation assembly and method for installing or replacing a sunroof drain tube in a vehicle includes a drain tube installation tool having an elongated flexible wire with a first end and a second end, and a stopper disposed at the second end of the wire. The wire is threaded through the sunroof drain tube to be installed on the vehicle and then through a sunroof drain tube passageway defined on the vehicle. Optionally, this includes threading the wire through a sunroof drain tube already installed on the vehicle. After threading, the wire is pulled to forcibly install the sunroof drain tube into the sunroof drain tube passageway and, optionally, displacing the previously installed sunroof drain tube.

### BACKGROUND

The subject disclosure generally relates to sunroof drain tubes in vehicles, and particularly relates to a sunroof drain tube installation assembly and method for installing and/or replacing a sunroof drain tube in a vehicle.

It is known that sunroof drain tubes in vehicles occasionally need to be replaced due to wear or leaks. Typically, sunroof drain tubes have an upper end fluidly connected to a gutter or channel area disposed about a periphery or beneath a sunroof on a vehicle and a lower end disposed at a location to which it is desirable to direct drainage from the sunroof. In some applications, the sunroof drain tube passes along or within the A-pillar on the vehicle. Heretofore, the space in which a sunroof drain tube was installed in such a pillar was large enough that the old drain tube could be easily removed and replaced. In particular, the old sunroof drain tube could be grasped in view of the plentiful space surrounding the tube and pulled out of the pillar.

As vehicle designs progress, it is becoming increasingly difficult to remove the sunroof drain tube from a vehicle pillar using conventional methods. In particular, it can be difficult because the sunroof drain tube is a blind installation within the pillar and thus removal requires work on portions of the sunroof drain tube that cannot be seen. Additionally, further structural components (e.g., bulkheads) are often added to the pillar in newer vehicle designs, which increases the difficulty in removing the sunroof drain tube. Still further, the pillar can receive a damping treatment, such as application of spray foam, thus increasing the difficulty in removing the sunroof drain tube from the pillar. Spray foam may be used to improve noise and/or vibration concerns for the vehicle. When spray foam is used, there is essentially no clearance around the sunroof drain tube and thus grasping of the sunroof drain tube, as was used in conventional removal techniques, is precluded. Moreover, spray foam is generally a relatively soft material and can be easily damaged if handled too roughly as might occur when applying conventional sunroof drain tube removal techniques.

### SUMMARY

According to one aspect, a method is provided for installing a sunroof drain tube in a vehicle. In the method, a drain tube installation tool is provided having an elongated flexible portion with a first end and a second end, and a stopper disposed at the second end of the elongated flexible portion. The first end of the elongated flexible portion is threaded through the sunroof drain tube to be installed on the vehicle. The first end of the elongated flexible portion is also threaded through a sunroof drain tube passageway defined on the vehicle. The first end of the elongated flexible portion is pulled to forcibly install the sunroof drain tube into the sunroof drain tube passageway. The stopper forcibly causes the sunroof drain tube to move into the sunroof drain tube passageway as the first end of the elongated flexible portion is pulled.

According to another aspect, a sunroof drain tube installation assembly is provided for installing a sunroof drain tube in a vehicle. The sunroof drain tube installation assembly includes an elongated flexible wire having a first end and a second end, a stopper disposed at the second end of the elongated flexible wire, and a sunroof drain tube to be installed on the vehicle. The elongated flexible wire has a diameter smaller than an inner diameter of the sunroof drain tube to allow the first end of the elongated flexible wire to be threaded into the sunroof drain tube, and has an axial length greater than an axial length of the sunroof drain tube to allow the first end of the elongated flexible wire to be threaded through the sunroof drain tube. The stopper is sized so as to have a radial dimension greater than the inner diameter of the sunroof drain tube to thereby prevent the second end of the elongated flexible wire from passing into the sunroof drain tube.

According to a further aspect, a method for replacing a sunroof drain tube in a vehicle is provided. In accordance with the method, a distal end of a wire portion of a drain tube installation tool is inserted into and through a replacement sunroof drain tube. The distal end of the wire portion is also inserted into and through an installed sunroof drain tube on the vehicle. The distal end of the wire portion is pulled so that a stopper of the drain tube installation tool disposed at an opposite end of the wire portion abuts an end of the replacement sunroof drain tube. The distal end of the wire portion is further pulled so that the replacement sunroof drain tube displaces the installed sunroof drain tube on the vehicle.

### BRIEF DESCRIPTION OF THE DRAWINGS

FIG. 1 is a schematic perspective view, partially in cross section, of a sunroof drain tube installation assembly including an installation tool for installing a replacement sunroof drain tube in place of a sunroof drain tube installed in the A-pillar of a vehicle.

FIG. 2 is a perspective view of the sunroof drain tube installation tool, which includes an elongated flexible wire and a stopper.

FIG. 3 is a schematic perspective, partially in cross section, showing only the installed sunroof drain tube installed in the A-pillar of a vehicle for draining a sunroof gutter area of the vehicle.

FIG. 4 is a view similar to FIG. 1, but showing the elongated wire of the drain tube installation tool threaded through both the replacement sunroof drain tube and the installed sunroof drain tube on the vehicle.

FIG. 5. Is another view similar to FIG. 4, but showing a first distal end of the elongated flexible wire being pulled such that the replacement sunroof drain tube is beginning to forcibly displace the installed sunroof drain tube within the vehicle.

FIG. 6 is yet another view similar to FIG. 4, but showing the replacement sunroof drain tube installed in the vehicle and fully displacing the originally installed sunroof drain tube, and further showing the drain tube installation tool being removed from the sunroof drain tubes.

FIG. 7 is a block diagram illustrating a method for installation/replacing a sunroof drain tube on a vehicle.

### DETAILED DESCRIPTION

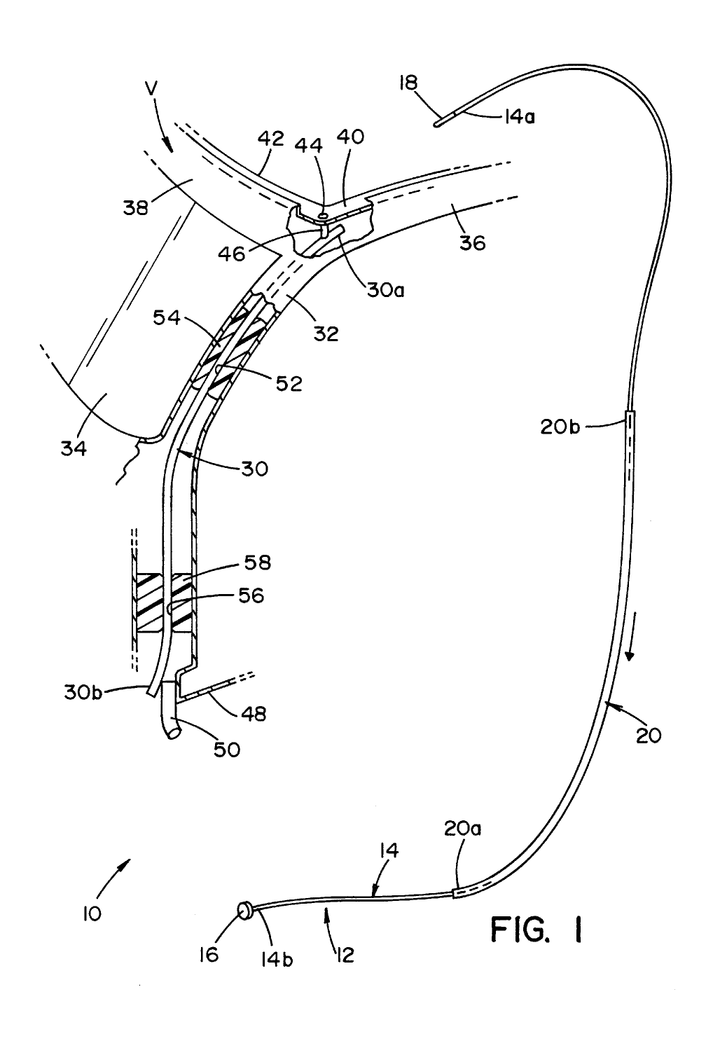

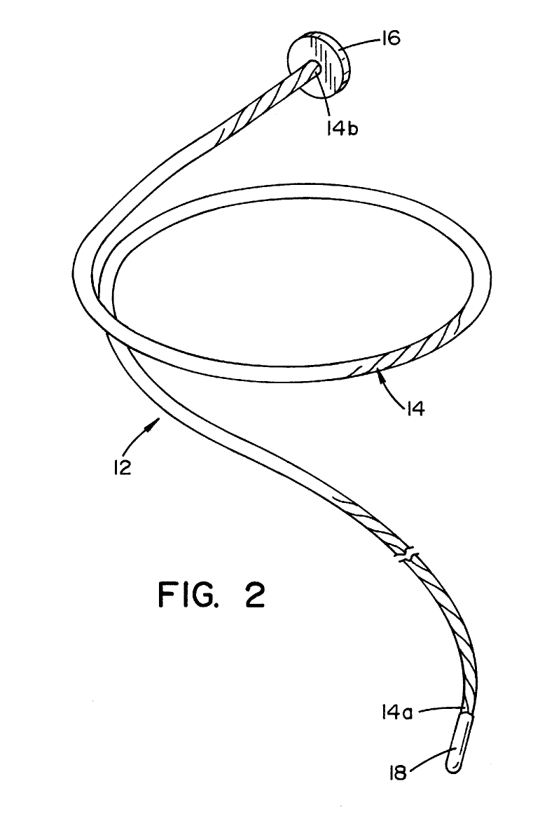

Referring now to the drawings wherein the showings are for purposes of illustrating one or more exemplary embodiments and not for limiting same, FIG. 1 shows a sunroof drain tube installation assembly 10 for installing and/or replacing a sunroof drain tube in a vehicle V. More particularly, and with additional reference to FIG. 2, the illustrated sunroof drain tube installation assembly 10 includes a drain tube installation tool 12. The drain tube installation tool 12, and thus the drain tube installation assembly 10, includes an elongated flexible portion or wire 14 having a first end 14a and a second end 14b, and a stopper 16 disposed at the second end 14b of the elongated flexible wire 14. As shown in the illustrated embodiment, the elongated flexible wire 14 can be a braided wire having a cap 18 at the first end 14a to facilitate threading of the elongated flexible wire 14 into a sunroof drain tube, as will be described in more detail below. The cap 18 can function to keep the first end 14a of the flexible wire 14 from unbraiding or fraying.

The assembly 10 can further include a sunroof drain tube 20 that is to be installed on the vehicle V. As shown, the elongated flexible wire 14 has a diameter smaller than an inner diameter of the sunroof drain tube 20 to allow the first end 14a of the elongated flexible wire 14 to be threaded into the sunroof drain tube 20. Additionally, the elongated flexible wire 14 has an axial length greater than an axial length of the sunroof drain tube 20 to allow the first end 14a of the elongated flexible wire 14 to be threaded completely through the sunroof drain tube 20 as shown in FIG. 1. Still further, and as shown in the illustrated embodiment, the stopper 16 can be sized so as to have a radial dimension greater than the inner diameter of the sunroof drain tube 20 to thereby prevent the second end 14b of the elongated flexible wire 14 from passing into and through the sunroof drain tube 20.

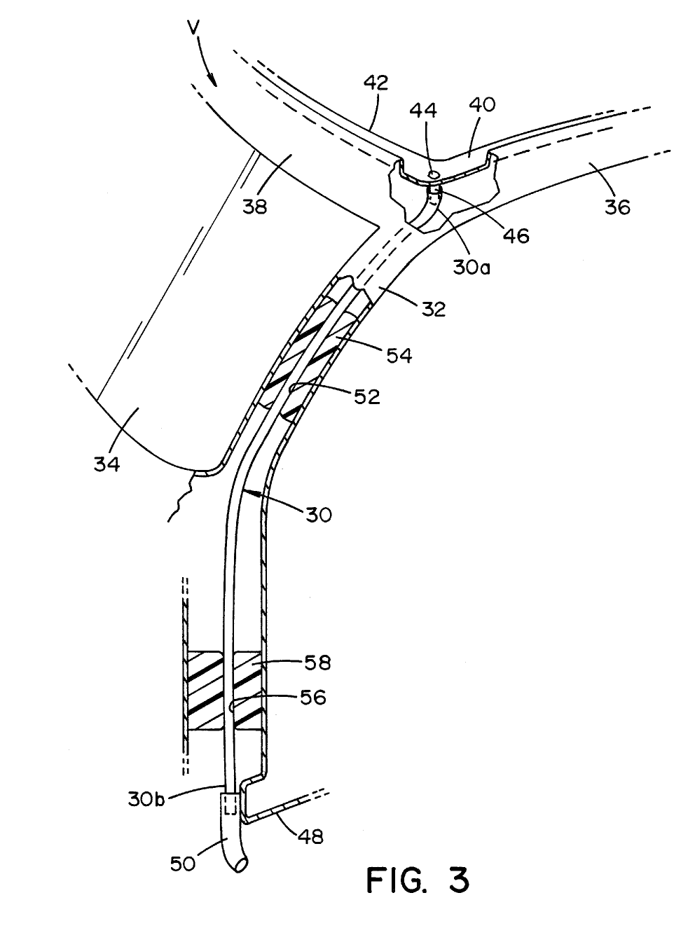

With additional reference to FIG. 3, a sunroof drain tube 30 is shown installed on the vehicle V and can be referred to as an installed sunroof drain tube. In particular, the installed sunroof drain tube 30 is shown installed through a pillar 32 on the vehicle V. The pillar 32 can be an A-pillar extending along the vehicle's windshield 34 from a location at or adjacent an intersection between a longitudinal roof rail 36 and a lateral roof rail 38. The pillar 32 can extend down from this intersection along a lateral edge of the windshield 34 as is known and understood skilled in the art. Alternatively, the pillar 32 could be some other pillar on the vehicle V. The installed sunroof drain tube 30 can be fluidly connected to a gutter area 40 on the vehicle V, such as the illustrated gutter area 40 defined by the roof rails 36, 38 in the illustrated embodiment. As is known and understood by those skilled in the art, the gutter area 40 can be disposed about a periphery of a sunroof (not shown) of the vehicle V and/or about a periphery of a sunroof opening 42 for such a sunroof. It will become apparent, at least to those skilled in the art, that the sunroof, sunroof opening and vehicle need not be as shown in the illustrated embodiment as the showings are merely exemplary.

In the illustrated embodiment, a drainage aperture 44 is defined in the gutter area 40 and is fluidly connected to the installed sunroof drain tube 30. More particularly, as shown, a drain member or grommet 46 can be disposed at the location of the drainage aperture 44 for providing a structure to which a first or upper end 30a of the installed sunroof drain tube 30 can be connected to the aperture 44 and thereby to the gutter area 40. As shown, the sunroof drain tube 30 can extend through the pillar 32 to a location spaced apart vertically from the gutter area 40 and, in the illustrated embodiment, further extends down the vehicle to a location adjacent an underside 48 of the vehicle V. In particular, in the illustrated embodiment, a second or lower end 30b of the installed sunroof drain tube 30 can be connected to a grommet 50 secured adjacent the underside 48 of the vehicle V for directing fluid (e.g., rain water) from the gutter area 40 through the drain tube 30 and out beneath the vehicle V via the grommet 50.

In the illustrated embodiment, the installed sunroof drain tube 30 passes through an aperture 52 defined at least through spray foam insulation 54 disposed within the pillar 32, the spray foam insulation advantageously reducing noise and vibrations within the vehicle V. As shown, the diameter of the aperture 52 can substantially match an outer diameter of the installed sunroof drain tube 30 to minimize radial gaps therebetween. Additionally, in the illustrated embodiment, the installed sunroof drain tube 30 can pass through another aperture 56 defined through additional spray foam insulation 58 wherein again the diameter of the aperture 56 substantially matches the outer diameter of the installed sunroof drain tube 30 to minimize radial gaps therebetween. In the illustrated embodiment, this additional spray foam insulation 58 is disposed within the A-pillar 32 at a location spaced vertically below the windshield 34. It is to be appreciated, however, that spray foam insulation or other tightly packed surrounding elements can be disposed within the pillar 32 at any location therealong or along the entire longitudinal extent of the pillar 32. The apertures 52, 56 together define and/or form a sunroof drain tube passageway within the vehicle V, and particularly within the pillar 32 of the vehicle V. The installed sunroof drain tube 30 is fit complimentarily within this drain tube passageway such that there is no clearance area disposed radially about the installed sunroof drain tube 30, at least along portions of the drain tube 30.

Returning reference to FIG. 1, it is noted that the sunroof drain tube 20 can be a replacement sunroof drain tube that is used to replace the installed sunroof drain tube 30. Replacement of the already installed sunroof drain tube 30 might be necessary due to wear or leaks related to the installed sunroof drain tube 30. As noted, particularly in relation to the spray foam 54, 58, it may be difficult to gain access to the sunroof drain tube 30, particularly along its entire length and therefore it may be difficult to remove the installed sunroof drain tube 30 through conventional techniques (e.g., opening the pillar 32 and grasping the installed sunroof drain tube 30 at points along its entire longitudinal length to remove same from the pillar 32). Accordingly and as will be described in more detail below, the assembly 10, including the drain tube installation tool 12 and the replacement drain tube 20, can be used to both remove the installed sunroof drain tube 30 and install the replacement drain tube 20 within the vehicle V.

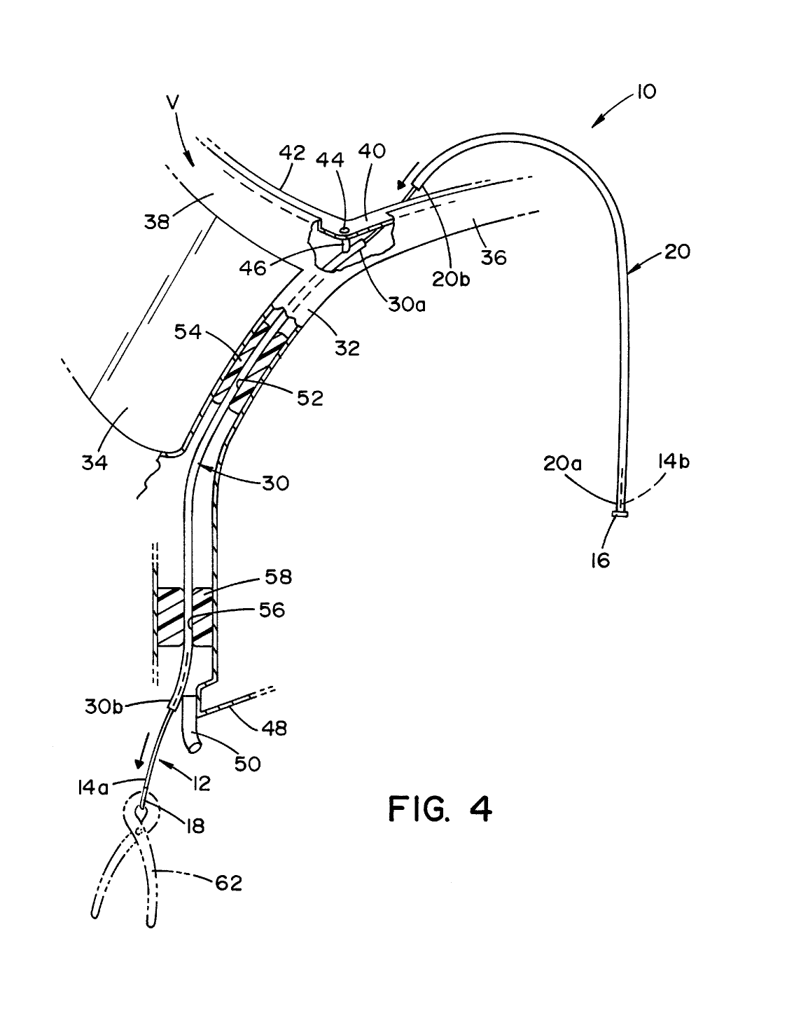

In this regard, the replacement sunroof drain tube 20 can have an outer diameter that is substantially the same as the outer diameter of the installed sunroof drain tube 30 on the vehicle V that is to be replaced by the replacement sunroof drain tube 20. Additionally, the replacement sunroof drain tube 20 can have a length substantially the same as the installed sunroof drain tube 30. These dimensional matches can facilitate displacement of the installed sunroof drain tube 30 by the replacement sunroof drain tube 20 when the elongated flexible wire 14 is serially threaded the replacement sunroof drain tube 20 and the installed sunroof drain tube 30 and the first end of the wire 14 then pulled, as is shown in FIGS. 4-6.

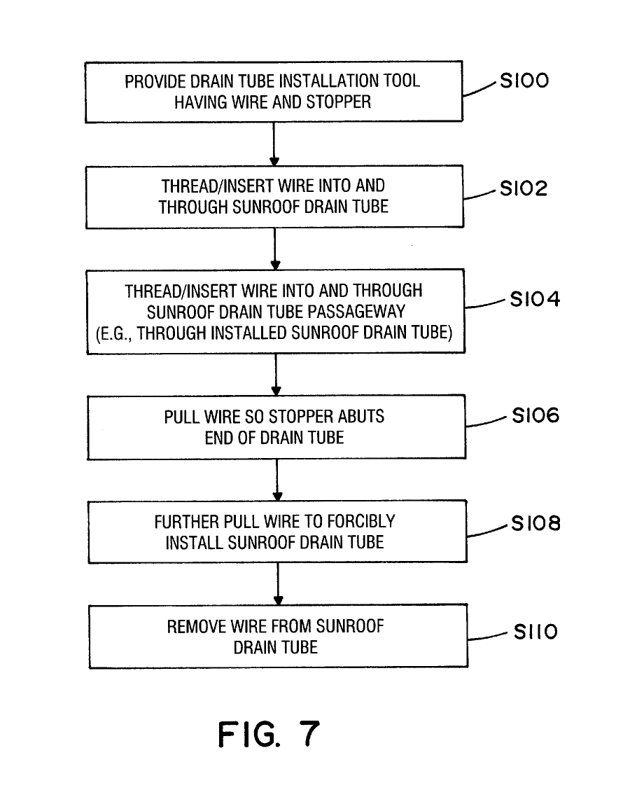

A method for installing and/or replacing a sunroof drain tube in a vehicle will now be described with specific reference to FIG. 7. In particular, the method will be described in association with the sunroof drain tube installation assembly 10 described hereinabove, though this is not required. In the method at S100, the drain tube installation tool 12, such as shown in FIG. 2, can be provided having the elongated flexible wire 14 with first end 14a and second end 14b, and the stopper 16 disposed at the second end 14b of the wire 14. As shown in FIG. 1, the first or distal end 14a of the wire 14 is threaded or inserted into and through the sunroof drain tube 20 at S102. After threading/inserting into and through the sunroof drain tube 20 at S102, the first end 14a of the wire 14 can be threaded through a sunroof drain tube passageway defined on the vehicle V at S104. The passageway can be the space defined in the pillar 32 in which the installed sunroof drain tube 30 resides and/or the portion thereof defined through components within the pillar 32, such as the apertures 52, 56.

In particular, when the sunroof drain tube 30 is already installed on the vehicle V, the first or distal end 14a of the wire 14 can be inserted in S104 into and through the installed sunroof drain tube 30 on the vehicle V as shown in FIG. 4. Thus, threading/inserting the first end 14a of the wire 14 into and through the passageway of the vehicle V can encompass threading/inserting the wire 14 into and through the installed sunroof drain tube 30. Prior to such threading of the first end 14a of the wire 14 through the installed sunroof drain tube 30, the first upper end 30a of the installed sunroof drain tube 30 can be disconnected from the drain grommet 46 as shown in FIG. 1. Likewise, the second lower end 30b of the installed sunroof drain tube 30 can be disconnected from the drain grommet 50 as also shown in FIG. 1. Once the wire 14 is inserted, in S106, the distal end 14a is pulled as shown in FIG. 4 so that the stopper 16 of the drain tube installation tool 12 abuts the end 20a of the replacement sunroof drain tube 20.

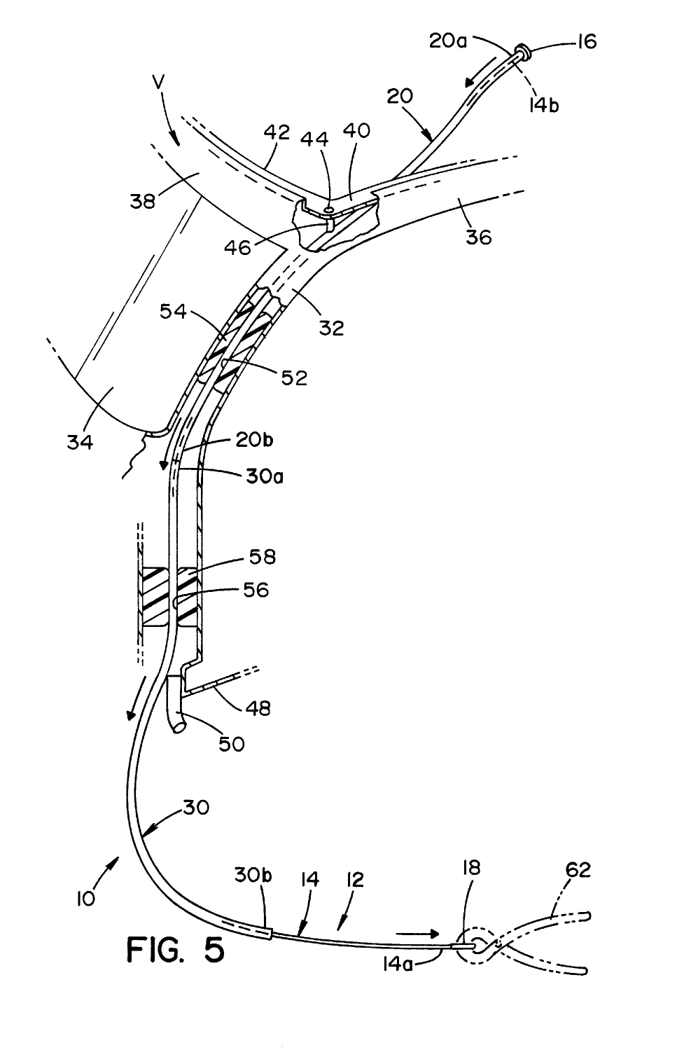

The distal end 14a can then be further pulled in S108 as shown in FIG. 5 so that the replacement sunroof drain tube 20 displaces the installed sunroof drain tube 30 on the vehicle V, or otherwise occupies the sunroof drain tube passageway defined through the pillar 32. Such pulling of the first end 14a of the wire 14 results in a forcible install of the sunroof drain tube 20 into the sunroof drain tube passageway. In particular, the stopper 16 forcibly causes the sunroof drain 20 to move into the sunroof drain tube passageway of the pillar 32 as the first end 14a of the wire 14 is pulled. As shown, a tool 62 can be used to facilitate such pulling of the end 14a of the wire 14, though it will be appreciated that tools other than that illustrated can be used. Specifically, pulling of the wire 14 causes a leading end 20b of the replacement sunroof drain tube 20 to abut the upper end 30a of the installed sunroof drain tube 30 and forcibly pushes the installed sunroof drain tube 30 from the installed position illustrated in FIGS. 1 and 3 on the vehicle V. The distal end 14a of the wire 14 is further pulled until the installed sunroof drain tube 30 is fully removed from the vehicle V and the replacement sunroof drain tube 20 occupies the passageway previously occupied by the installed sunroof drain tube 30.

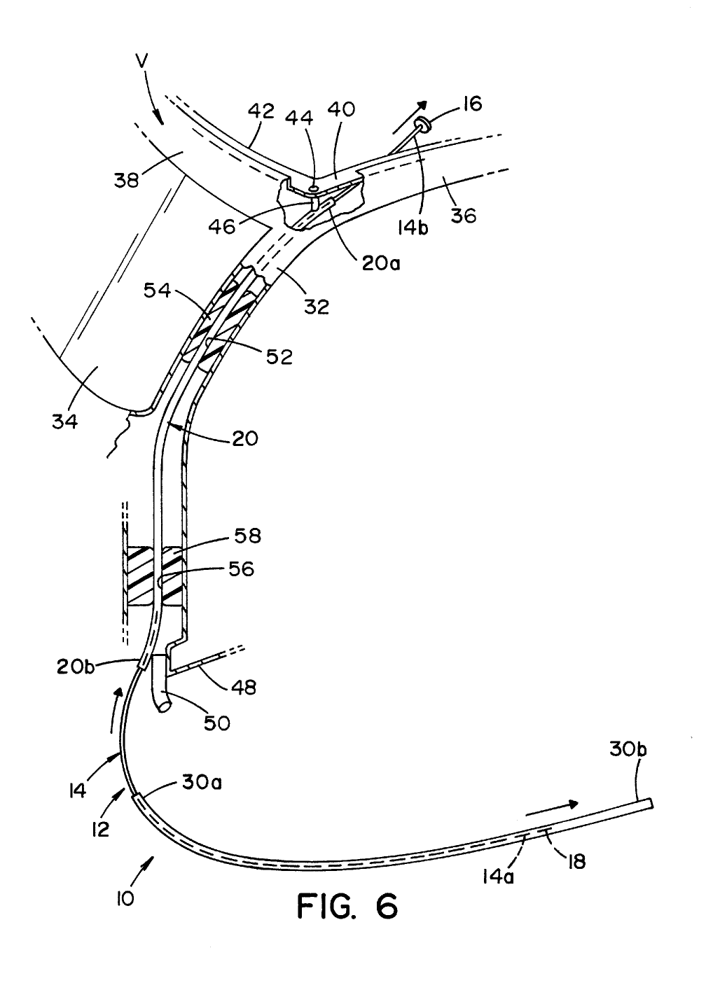

After installation, and as shown in FIG. 6, the wire 14 and thus the tool 12 can be removed from the replacement sunroof drain tube 20 and the installed sunroof drain tube 30 in S110. In particular, the drain tube installation tool 12 can be removed after the sunroof drain tube 20 is installed into the sunroof drain tube passageway by pulling the stopper 16 away from the sunroof drain tube passageway until the elongated wire 14 is removed therefrom. When displacing an installed sunroof drain tube, such as tube 30, the installation tool 12 is removed by pulling the stopper 16 until the wire 14 is removed from both sunroof drain tubes 20, 30.

Thereafter, the first upper end 20a of the sunroof drain tube 20 can be connected to the sunroof drain 44 and the second lower end 20b of the sunroof drain tube 20 can be connected to the drain grommet 50 spaced apart from the sunroof drain 44. In particular, the end 20a of the tube 20 can be fluidly connected to the sunroof gutter or gutter area 40 on the vehicle V and likewise the second, opposite end 20b can be fluidly connected to the drainage grommet 50 vertically spaced below the sunroof gutter 40 on the vehicle V. Advantageously, the installation of the sunroof drain tube 20 (and displacement of the installed sunroof drain tube 30) can be done relatively easy and in a short period of time. Further, removal of the installed sunroof drain tube 30 and installation of the replacement sunroof drain tube 20 can occur without damaging the foam 54, 58.

It will be appreciated that various of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A method for installing a sunroof drain tube in a vehicle, comprising:
providing a drain tube installation tool having an elongated flexible portion with a first end and a second end, and a stopper disposed at the second end of the elongated flexible portion;
threading the first end of the elongated flexible portion through the sunroof drain tube to be installed on the vehicle;
threading the first end of the elongated flexible portion through a sunroof drain tube passageway defined on the vehicle; and
pulling the first end of the elongated flexible portion to forcibly install the sunroof drain tube into the sunroof drain tube passageway, the stopper forcibly causing the sunroof drain tube to move into the sunroof drain tube passageway as the first end of the elongated flexible portion is pulled.

2. The method of claim 1 wherein the drain tube installation tool is removed after the sunroof drain tube is installed into the sunroof drain tube passageway by pulling the stopper away from the sunroof drain tube passageway until the elongated flexible portion is removed from the sunroof drain tube passageway.

3. The method of claim 1 further including:
connecting a first upper end of the sunroof drain tube to a sunroof drain; and
connecting a second lower end of the sunroof drain tube to a drain grommet spaced apart from the sunroof drain.

4. The method of claim 1 wherein the sunroof drain tube is a replacement sunroof drain tube and threading the first end of the elongated flexible portion through the sunroof drain tube passageway includes threading the first end of the elongated flexible portion through an installed sunroof drain tube that is to be replaced by the replacement sunroof drain tube, the installed sunroof drain tube installed on the vehicle.

5. The method of claim 4 wherein the installed sunroof drain tube is disposed within an A-pillar of the vehicle, the sunroof drain tube passageway formed through spray foam insulation such that a cross-sectional diameter of the passageway is sized to closely fit the installed sunroof drain tube.

6. The method of claim 4 further including, prior to threading the first end of the elongated flexible portion through the installed sunroof drain tube:
disconnecting a first upper end of the installed sunroof drain tube from a sunroof drain; and
disconnecting a second lower end of the installed sunroof drain tube from a drain grommet.

7. The method of claim 1 wherein the sunroof drain tube passageway is defined by a foam part disposed in a pillar of the vehicle.

8. A sunroof drain tube installation assembly for installing a sunroof drain tube in a vehicle, comprising:
an elongated flexible wire having a first end and a second end;
a stopper disposed at the second end of the elongated flexible wire; and
a sunroof drain tube to be installed on the vehicle, wherein the elongated flexible wire has a diameter smaller than an inner diameter of the sunroof drain tube to allow the first end of the elongated flexible wire to be threaded into the sunroof drain tube, and has an axial length greater than an axial length of the sunroof drain tube to allow the first end of the elongated flexible wire to be threaded through the sunroof drain tube, and further wherein the stopper is sized so as to have a radial dimension greater than the inner diameter of the sunroof drain tube to thereby prevent the second end of the elongated flexible wire from passing into the sunroof drain tube.

9. The sunroof drain tube installation assembly of claim 8 wherein the elongated flexible wire is a braided wire having a cap at the first end to facilitate threading of the elongated flexible wire into the sunroof drain tube.

10. The sunroof drain tube installation assembly of claim 8 wherein the sunroof drain tube is a replacement sunroof drain tube that has an outer diameter that is substantially the same as an outer diameter of an installed sunroof drain tube on the vehicle that is to be replaced by the replacement sunroof drain tube for facilitating displacement of the installed sunroof drain tube by the replacement sunroof drain tube when the elongated flexible wire is serially threaded through the replacement sunroof drain tube and the installed sunroof drain tube and the first end then pulled.

11. The sunroof drain tube installation assembly of claim 8 wherein the sunroof drain tube is a replacement sunroof drain tube, wherein the assembly further includes:
an installed sunroof drain tube installed through a pillar on the vehicle, the replacement sunroof drain tube having a diameter and length substantially the same as the installed sunroof drain tube.

12. The sunroof drain tube installation assembly of claim 11 wherein the installed sunroof drain tube passes through an aperture defined through spray foam insulation wherein the diameter of the aperture substantially matches an outer diameter of the installed sunroof drain tube to minimize radial gaps therebetween.

13. The method of claim 1 wherein the sunroof drain tube is a replacement sunroof drain tube and the elongated flexible portion is a wire portion, the method further including:
inserting the first end of the wire portion into and through an installed sunroof drain tube on the vehicle;
pulling the first end of the wire portion so that the stopper of the drain tube installation tool abuts an end of the replacement sunroof drain tube; and
further pulling the first end of the wire portion so that the replacement sunroof drain tube displaces the installed sunroof drain tube on the vehicle.

14. The method of claim 13 further including:
removing the wire portion of the drain tube installation tool from the sunroof drain tubes.

15. The method of claim 14 further including:
fluidly connecting the end of the replacement sunroof drain tube to a sunroof gutter on the vehicle; and
fluidly connecting a second, opposite end of the sunroof replacement drain tube to a drainage grommet vertically spaced below the sunroof gutter on the vehicle.

16. The method of claim 15 further including:
disconnecting a first end of the installed sunroof drain tube from the sunroof gutter prior to inserting the distal end of wire portion into and through the installed sunroof drain tube on the vehicle; and
disconnecting a second, opposite end of the installed sunroof drain tube from the drainage grommet on the vehicle.

17. The method of claim 13 wherein, prior to displacement, the installed sunroof drain tube extends along and within a pillar on the vehicle such that inserting the distal end of the wire portion into and through the installed sunroof drain tube includes inserting the distal end of the wire portion into and through a drain tube passageway defined through the pillar.

18. The method of claim 17 wherein, prior to displacement, the installed sunroof drain tube is fit complementarily within the drain tube passageway such that there is no clearance area disposed radially about the installed sunroof drain tube.

19. The method of claim 18 wherein, prior to displacement, the installed sunroof drain tube is surrounded by a foam member that defines the drain tube passageway.

20. The method of claim 13 wherein a leading end of the replacement sunroof drain tube abuts an upper end of the installed sunroof drain tube and forcibly pushes the installed sunroof drain tube from an installed position on the vehicle as the distal end of the wire portion is further pulled until the installed sunroof drain tube is fully removed from the vehicle and the replacement sunroof drain tube occupies the passageway previously occupied by the installed sunroof drain tube.
